(19) United States
(12) Patent Application Publication
(10) Pub. No.: US 2012/0324326 A1
(43) Pub. Date: Dec. 20, 2012

(54) METHOD AND APPARATUS FOR OUTPUTTING A MULTIMEDIA FILE OF A WEB PAGE

(76) Inventor: Jin Woo Kim, Seoul (KR)

(21) Appl. No.: 13/580,127

(22) PCT Filed: Mar. 9, 2011
(86) PCT No.: PCT/KR2011/001618

§ 371 Date: Aug. 20, 2012

(30) Foreign Application Priority Data
Mar. 10, 2010 (KR) 10-2010-0021217

(51) Int. Cl. G06F 17/00

(52) U.S. Cl. 715/205

(57) ABSTRACT

A method and apparatus for playing back a multimedia file of a web page containing link codes. The apparatus comprises: a media information setup unit which matches link codes contained in the web page to multimedia files, and sets up the matched link codes and multimedia files; a link address generating unit which generates a unique ID when the link code is clicked, and regenerates a URL address of the link site being opened; a link site searching unit which searches the unique ID and state information from the opened link site, and transmits the search result to a media control unit; and the media control unit which receives the unique ID and the state information from the link site searching unit, and controls the playback of the multimedia file matched to the link site corresponding to the received unique ID.

### TECHNICAL FIELD

The present invention relates to a method and apparatus for playing back a multimedia file of a Web page containing link codes.

### BACKGROUND ART

Many efforts for implementing hyperlinks had been made for a few tens of years before World Wide Web (hereinafter, referred to as “Web”) was developed. HyperText Markup Language (HTML), HyperText Transfer Protocol (HTTP), Uniform Resource Identifier (URI), etc. were developed by Time Berners Lee. Finally, the original Web (Web 1.0) appeared by connecting HTML documents using a Web browser.

HTML is a markup language that is most frequently used these days, and became the basis of Web development as an application of Standard Generalized Markup Language (SGML). The HTML provides a basic structure in which HTML documents are expressed through a Web browser. HTTP is a protocol that manages communication between a client and a server in the Web. The client can send a request to the server using the HTTP, and the server can respond to the client using a document or error message corresponding to the request.

The terms “Web link,” “hypertext,” etc. were initially used as the term “link,” and then used as the term “hypertext.” Since the term “hypertext” may be construed as connection between only characters, the term “hyperlink” (hereinafter, referred to as “link”) is currently used.

A Web browser such as Microsoft Internet Explorer or Firefox is required to use Internet through a personal computer terminal. Thus, if a mouse cursor is put on a word linked on a Web page, the shape of the mouse cursor is changed into another shape. Then, if the corresponding word is pressed, the current Web page is moved to a Web site or document indicated by an address inserted into the word.

That is, additional information on a link is represented as a tag. For example, in a case where the information on a link is represented as <a href=“http://www.naver.com/” alt=‘NAVER’>naver</a> in the HTML, “naver” interposed between tags “a” is displayed as a link. If a mouse cursor clicks the link, the current site is moved to a corresponding site. In this case, a tag “alt” allows the word “NAVER” to be displayed when the mouse cursor is put on the link.

In a case where an appropriated multimedia file is simultaneously played back in a link site while moving to the corresponding link site when a tag is clicked, it is urgently required to develop an appropriate control technology.

### DETAILED DESCRIPTION

### Technical Problems

It is thus an object of the present invention to provide a method and apparatus for playing back a multimedia file of a Web page containing link codes, which can play back a multimedia file suitable for each link site with the link site and control the multimedia file when the link sites are opened through the link codes.

### Technical Solutions

To solve the objective, the present invention provides an apparatus for outputting a multimedia file of a Web page containing link codes in which addresses of link sites are inserted, the apparatus comprising: a media information setup unit 202 which matches link codes contained in the Web page to multimedia files, and sets up the matched link codes and multimedia files; a link address generating unit 204 which generates a unique ID when the link code is clicked, and regenerates a URL address of the link site being opened; a link site searching unit 206 which searches the unique ID and state information from the opened link site, and transmits the search result to a media control unit 208; and the media control unit 208 which receives the unique ID and the state information from the link site searching unit 206, and controls the playback of the multimedia file matched to the link site corresponding to the received unique ID.

### Advantageous Effects

Based on the above structure, it is possible to independently play back a multimedia file suitable for each link site with respect to different link sites.

### BRIEF DESCRIPTION OF DRAWINGS

FIG. 1 is a configuration diagram of a system for outputting a multimedia file using link codes of a Web site according to the present invention;

FIG. 2 is a diagram illustrating operations of a Web site and link sites according to the present invention; and

FIG. 3 is a flowchart illustrating a process of outputting a multimedia file of a Web page according to the present invention.

### BEST MODES FOR PRACTICING INVENTION

Hereinafter, the preferred present invention will be described in more detail with reference to the accompanying drawings. When adding reference numerals into constituents in each drawing set forth herein, like reference numerals refer to like elements throughout even they are shown in other drawings. Also, when explaining the present invention, if it is judged that the specific explanation of the related well-known constitution or function may make the gist of the present invention obscure, the detailed explanation thereof will be omitted.

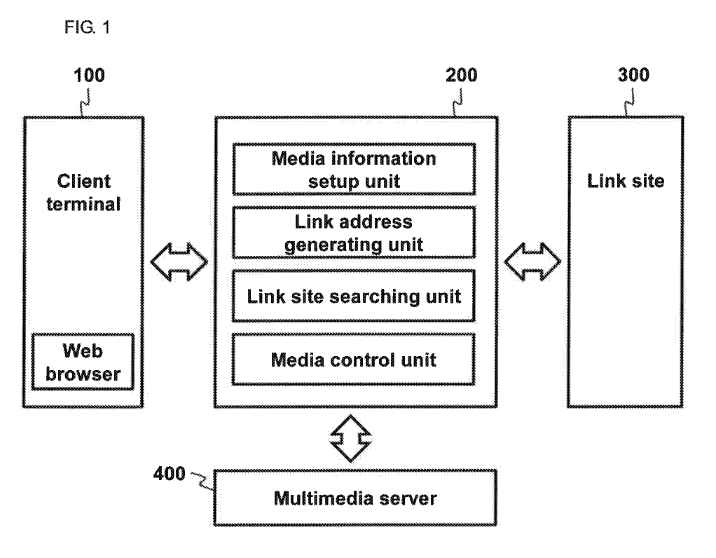

FIG. 1 is a configuration diagram of a system for outputting a multimedia file using link codes of a Web site according to the present invention.

As shown in FIG. 1, the system of the present invention comprises a client terminal 100, a Web site server 200, link sites 300 and a media server 400.

The client terminal 100 may be, for example, a personal computer, notebook computer, cellular phone, IPTV, PDA, PMP, etc. A Web browser 102 is installed in the client terminal 100 so that a main Web site containing link codes is downloaded and displayed on the Web browser 102. Thus, a user can access the link sites 300 through the Web browser 102.

When a Web document is downloaded to the Web browser 102 from the Web site server 200, the Web browser 102 receives the Web document containing link codes. The link codes contain a programming source that can be driven on the Web browser 102.

When the user accesses a Web site, the Web site server 200 provides a function of allowing a Web page containing link codes to be downloaded on the user's client terminal.

The Web site server 200 comprises a media information setup unit 302, a link address generating unit 304, a link site searching unit 306 and a media control unit 308.

If a link code contained in a Web page is clicked so that a link site is opened, the media information setup unit 302 performs a function of matching and setting a playback route so that a multimedia file of the media server 400 can be played back. In the method in which the media information setup unit 302 matches multimedia files, the multimedia files may be matched at random or in a certain order. After a link code is clicked so that a link site is opened, the media information setup unit 302 may analyze contents of the opened link site and extract a keyword. Then, the media setup unit 302 may search for a multimedia file suitable for the keyword from the media server 400 and match the searched multimedia file to the keyword. In a case where the keyword extracted from the link site is ‘grief’ or ‘death,’ a file of sad and sorrowful music is played back to be suitable for the keyword. In a case where the keyword extracted from the link site is ‘soccer’ or ‘victory,’ a file of cheerful and pleasant music is searched and played back. Thus, if a user clicks a link code contained in a Web page so that a link site indicated by the address of the link code is opened, a multimedia file matched to the link code is downloaded along a playback route and then played back.

If a user clicks a link code so that a link site is opened, the link address generating unit 304 generates a uniform resource locator (URL) address of the opened link site. That is, if the user clicks the link code, the link address generating unit 304 generates a unique, non-duplicate ID with which the clicked link code can be distinguished, and opens the link site by combining the generated unique ID and the address of an existing link site contained in the link code and regenerating a new URL address of the link site. Thus, the link site searching unit 306 can search for the link code connected to the link site using the unique ID. The link site searching unit 306 may additionally contain a specific identifier that facilitates the searching of the unique ID when a new URL address is generated by combining the address of a link site and the unique ID.

The link site searching unit 306 identifies whether or not a unique ID exists by checking the address of a link site. If it is identifies that the unique ID exists, the link site searching unit 306 extracts the unique ID and transmits the extracted unique ID to the media control unit 308. The link site searching unit 306 also identifies state information of the link site and transmits the identified state information to the medial control unit 308. If the link site is opened and the focus of a mouse exists in the opened link site, the state information is set to an operation state. If the current link site is opened but the focus of the mouse does not exist in the link site, the state information is set to a pause state. If the link site is closed, the state information is set to a stop state.

The media control unit 308 receives a unique ID and state information from the link site searching unit 306. The media control unit 308 searches for a link code corresponding to the received unique ID and controls a multimedia file matched to the link code to be played back according to the received state information.

The link site 300 refers to a site connected by a URL address contained in a link code of the Web site server 200. If a user clicks a link code contained in a Web site, a link site corresponding to the link code is opened.

The media server 400 stores multimedia provided from the Web site server 200, and the stored multimedia is provided to the client terminal 100 through Internet. The media server 400 stores multimedia including music, voice texts, images, flashes, moving pictures, posts, etc.

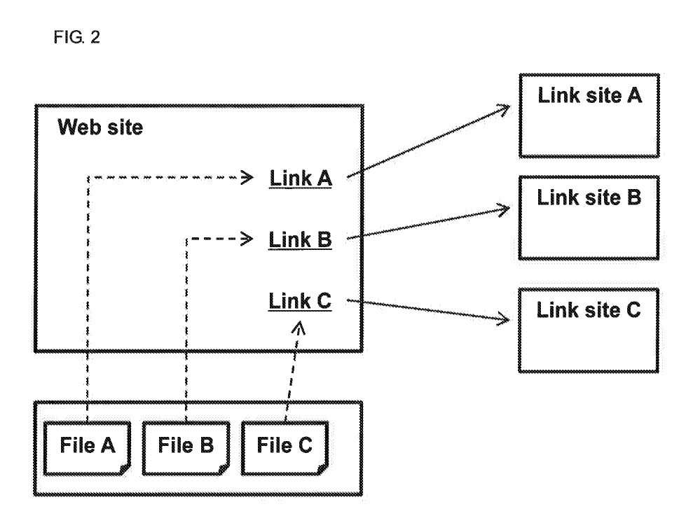

FIG. 2 is a diagram illustrating operations of a Web site and link sites according to the present invention.

If a user clicks link code A, link site A corresponding to the address connected to the link code A is opened, and multimedia file A of the multimedia server 400 is played back along route of the multimedia file matched by media information setup unit 302. If the user clicks link code B, link site B corresponding to the address connected to the link code B, and the focus of a window is changed from the link site A to the link site B. Therefore, the link site searching unit 306 detects the change and informs the media control unit 308 of the change. The media control unit 308 controls the multimedia file A being played back to be in a pause state, and plays back multimedia file B set in the link code B by the media information setup unit 302. Similarly, if the user clicks link code C, link site C corresponding to the address connected to the link code C is opened, and the focus of the window is changed from the link site B to the link site C. Therefore, the link site searching unit 306 detects the change and informs the media control unit 308 of the change. The media control unit 308 controls the multimedia file B being played back to be in a pause state, and plays back multimedia file C set in the link code C by the media information setup unit 302.

If the user changes the focus of the window from the link site C to the link site A, the link site searching unit 306 detects the change and informs the media control unit 308 of the change. The media control unit 308 changes the state of the multimedia file C connected to the link site C into a pause state, and replays the multimedia file C being in the pause state. Similarly, the user closes the link site A during the playback of the multimedia file A, the link site searching unit 306 detects the close and informs the media control unit 308 of the close. The media control unit 308 changes the state of the multimedia file A connected to the link site A into a pause state, and replays the multimedia file B connected to the link site B to which the focus of the window is moved.

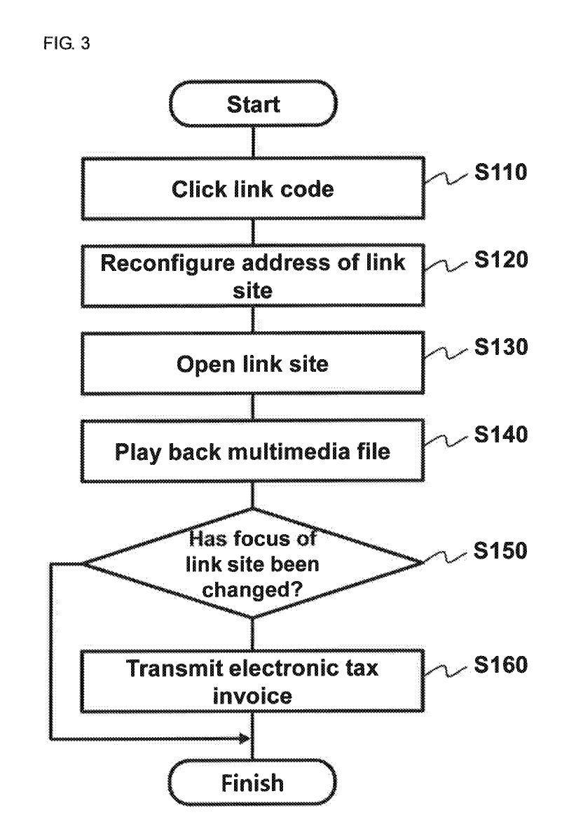

FIG. 3 is a flowchart illustrating a process of outputting a multimedia file of a Web page according to the present invention.

First, a Web page accessible through the Internet of the Web site server 200 contains a plurality of link codes. A user accesses the Web site server 200 through the client terminal 100 and clicks a link code of the Web page (S110). In this case, the link address generating unit 304 generates a unique ID of a link site opened by the link code, and reconfigures a new URL address of the link site by combining the generated unique ID and the address of an existing link site contained in the link code (S120). In this case, the link site searching unit 306 may additionally contain a specific identifier that facilitates the searching of the unique ID when a new URL address is generated by combining the address of a link site and the unique ID.

The link site corresponding to the address connected to the link code clicked by the user is opened, and the reconfigured URL address is displayed on the address window of the link site (S130). A multimedia file of the multimedia server 400 is downloaded and played back along the route of the multimedia file matched by the media information setup unit 302 (S140). To this end, the media information setup unit 302 may match, at random or in a certain order, multimedia files to the link codes clicked by the user. Alternatively, after the link code is clicked so that the link site is opened, the media information setup unit 302 may analyze contents of the opened link site, extract a keyword and match a multimedia file to the link code by searching for the multimedia file suitable for the keyword from the media server 400.

If a change in the focus of a link site is detected through the movement of the focus (S150), the link site searching unit 306 extracts a unique ID from the address window of the link site in which the change occurs, and searches for a link code corresponding to the link site. Since a multimedia file is connected to the link code, the media control unit 308 controls the multimedia file to be played back according to the change in the focus of the link site (S160). If the focus exists in the link site, the media control unit 308 plays back the multimedia file connected to the link code of the link site. If the link site is opened but the focus of the mouse does not exist in the link site, the media control unit 308 sets the playback of the multimedia file connected to the link code of the link site to be in a pause state. If the link site is closed, the media control unit 808 finishes the playback of the multimedia file connected to the link code of the link site.

Although the present invention has been described in connection with the accompanying drawings and the preferred embodiments, the present invention is not limited thereto but defined by the appended claims. Accordingly, it will be understood by those skilled in the art that various modifications and changes can be made thereto without departing from the spirit and scope of the invention defined by the appended claims.

### INDUSTRIAL APPLICABILITY

The present invention can be applied to industries related to the method and apparatus for playing back a multimedia file of a Web page containing link codes.

1. An apparatus for outputting a multimedia file of a Web page containing link codes in which addresses of link sites are inserted, the apparatus comprising:
a media information setup unit 202 which matches link codes contained in the Web page to multimedia files, and sets up the matched link codes and multimedia files;
a link address generating unit 204 which generates a unique ID when the link code is clicked, and regenerates a URL address of the link site being opened;
a link site searching unit 206 which searches the unique ID and state information from the opened link site, and transmits the search result to a media control unit 208; and
the media control unit 208 which receives the unique ID and the state information from the link site searching unit 206, and controls the playback of the multimedia file matched to the link site corresponding to the received unique ID.

2. The apparatus according to claim 1, wherein the media information setup unit 202 matches, in a certain order or at random, the multimedia files to the link codes.

3. The apparatus according to claim 1, wherein, after the link code is clicked so that a link site is opened, the media information setup unit 202 analyzes contents of the opened link site, extracts a keyword and then matches a multimedia file to the link code by searching for the multimedia file suitable for the keyword from the media server 400.

4. The apparatus according to claim 1, wherein the link address generating unit 204 generates a new uniform resource locator (URL) address by combining the address of a link site inserted in the link code and the generated unique ID.

5. The apparatus according to claim 1, wherein the link address generating unit 204 generates a new URL address by the address of the link site inserted in the link code, the generated unique ID and a specific identifier that facilitates the searching of the unique ID.

6. The apparatus according to claim 1, wherein the link site searching unit 206 identifies whether or not a unique ID exists by checking the address of a link site.

7. The apparatus according to claim 1, wherein the state information is set to an operation state when the link site is opened and the focus of a mouse exists, the state information is set to a pause state when the current link site is opened but the focus of the mouse does not exist, and the state information is set to a stop state when the link site is closed.

8. The apparatus according to claim 1, wherein the media control unit 208 searches for a link code corresponding to the received unique ID and controls a multimedia file matched to the link code to be played back according to the received state information.

9. A method for outputting a multimedia file of a Web page containing link codes in which addresses of link sites are inserted, the method comprising:
a first step of generating, by a link address generating unit 204, a unique ID of a link site opened by a link code and reconfiguring a new URL address of the link site, when the link code of the Web page is clicked;
a second step of opening the link site corresponding to the reconfigured URL address, and playing back a multimedia film matched to the link code by a media information setup unit 202;
a third step of detecting, by a link site searching unit 206, a change in the focus of a link site, extracting a unique ID from the address window of the link site in which the change occurs, and transmitting the unique ID and state information to a media control unit 208; and
a fourth step of controlling, the media control unit 208, the multimedia file to be played back in consideration of the received unique ID and state information.

10. The method according to claim 9, wherein the first step includes generating a new URL address by combining the address of a link site inserted in the link code and the generated unique ID.

11. The method according to claim 9, wherein the first step includes generating a new URL address by the address of the link site inserted in the link code, the generated unique ID and a specific identifier that facilitates the searching of the unique ID.

12. The method according to claim 9, wherein the second step includes matching, in a certain order or at random, the multimedia files to the link codes.

13. The method according to claim 9, wherein, after the link code is clicked so that a link site is opened, the media information setup unit 202 analyzes contents of the opened link site, extracts a keyword and then matches a multimedia file to the link code by searching for the multimedia file suitable for the keyword from a media server 400.

14. The method according to claim 9, wherein, in the fourth step, the state information is set to an operation state when the link site is opened and the focus of a mouse exists, the state information is set to a pause state when the current link site is opened but the focus of the mouse does not exist, and the state information is set to a stop state when the link site is closed.

15. The method according to claim 9, wherein, in the fourth step, the media control unit 208 searches for a link code corresponding to the received unique ID and controls a multimedia file matched to the link code to be played back according to the received state information.
